(19) United States
(12) Patent Application Publication
(10) Pub. No.: US 2006/0136652 A1
(43) Pub. Date: Jun. 22, 2006

(54) Electronic system with remap function and method for generating bank with remap function

(75) Inventors: Meng-Huang Chu, Shindian City (TW); Ding-Lung Chang, Shindian City (TW); Haw-Kuen Su, Shindian City (TW)

Correspondence Address: BACON & THOMAS, PLLC, 625 SLATERS LANE, FOURTH FLOOR, ALEXANDRIA, VA, 22314, US

(73) Assignee: VIA Technologies, Inc., Shindian City (TW)

(21) Appl. No.: 11/016,838

(22) Filed: Dec. 21, 2004

(51) Int. Cl. G06F 12/06

(52) U.S. Cl. 711/5

(57) ABSTRACT

An electronic system with remap function comprises a memory unit, a remap unit, and a microprocessor. The memory unit at least has a first bank and a second bank, which have a common area and a non-common area, respectively. The common area of the first bank comprises an addressing table and the common area of the second bank comprises at least one remap program code. The remap unit receives an address data, a bank selecting data, and a remap data, and then generates an embodied bank selecting data according to the remap data and the bank selecting data, and generates an embodied address data according to the remap data and the address data. The microprocessor fetches the original program code from the first bank or the second bank, or fetches the remap program code from the second bank according to the embodied bank selecting data and the embodied address data.

### BACKGROUND OF THE INVENTION

1. Field of Invention

The invention relates to an electronic system and, in particular, to an electronic system with a remap function and a method for generating a bank with a remap function.

2. Related Art

To enable an electronic system, many kinds of technologies, such as the hardware and software technologies, should be integrated. Taking a DVD system as an example, various hardware, software, and/or firmware are necessary to make the DVD system function normally. The DVD system has a device for storing important programs, data, and program codes, and those programs, data, and program codes, which cannot be changed by general users, are the so-called firmware.

In general, a firmware development tool (e.g. C51 of the Keil C) is used to compile and link the program of the electronic system firmware and then to record the firmware into the memory, which stores the firmware, of the electronic system. The memory used to save the firmware of the electronic system has a plurality of banks. The capacity of each bank is usually 64 KB, so that two or more banks are required to save the firmware if the firmware size is greater than 64 KB.

Referring to the FIG. 1, the layout of a bank B₁ comprises two areas, including a common area 31 and a non-common area 32. The common area 31 comprises the important programs, data, and an addressing table. The non-common area 32 comprises the program codes.

Referring to the FIG. 2, when the firmware size is 256 KB, four banks B₁, B₂, B₃, and B₄ are necessary to save the firmware. The common area 31 of each bank comprises the same addressing table 311. When a microprocessor 20 receives an address data D₀ and bank selecting data S₁₁, S₁₂, each of which has one bit, the microprocessor 20 will retrieve the function code from the corresponding address of the bank in accordance with the address data D₀ and bank selecting data S₁₁, S₁₂, and then perform the function code. For example, when the address data D₀ and the bank selecting data S₁₁, S₁₂ that the microprocessor 20 receives direct to the address of a first program code stored in a first bank B₁, the microprocessor 20 retrieves the first program code from the designated address and performs the retrieved first program code. If the first program code 321 needs to call the second program code 322 stored in the third bank B₃, the following steps are performed in sequence. In the first step, the addressing table, which is stored in the common area 31 of the first bank B₁, is called. In the second step, the addressing table 311 of the first bank B₁ is mapped to the addressing table 311 stored in the third bank B₃. In the third step, the second program code 322 stored in the third bank B₃ is called according to the addressing table 311 of the third bank B₃. Accordingly, the calling procedure is finished.

However, the common area of each bank has the same contents, resulting in storage capacity waste of the bank. Regarding to the present technology, which requests high efficiency and utility rate, the conventional design of the common area does not meet the requests. It is therefore a subjective of the invention to utilize the common area of the bank more efficient.

### SUMMARY OF THE INVENTION

In view of the foregoing, the invention is to provide an electronic system with a remap function and a method for generating a bank with a remap function.

To achieve the above, an electronic system with a remap function of the invention comprises a memory unit, a remap unit, and a microprocessor. The memory unit at least has a first bank and a second bank, wherein both banks have a common area and a non-common area, respectively. The common area of the first bank comprises an addressing table, the common area of the second bank comprises at least one remap program code, and each non-common area of the first bank and the second bank comprises at least one original program code. The remap unit receives an address data, a bank selecting data, and a remap data. The remap unit generates an embodied bank selecting data in accordance with the remap data and the bank selecting data, and generates an embodied address data in accordance with the remap data and the address data. The microprocessor fetches the original program code from the first bank or the second bank, or fetches the remap program code from the second bank in accordance with the embodied bank selecting data and the embodied address data.

Additionally, the invention also discloses a method for generating a bank with a remap function, which is cooperated with at least one first bank and a second bank. Each of the first bank and the second bank has a common area and a non-common area. The common area of the first bank comprises an addressing table, and the non-common area of the first bank and the non-common area of the second bank comprise at least one original program code respectively. The method for generating a bank with a remap function comprises the following steps of: addressing at least one remap program code into a virtual bank; and transferring the remap program code from the virtual bank to the common area of the second bank so as to generate the bank with a remap function.

As mentioned above, the electronic system with a remap function and the method for generating a bank with a remap function of the invention keep only one addressing table for all of the common areas, which comprise the same contents in the conventional banks, during the firmware development stage. After that, an additional remap program code is added into the common area(s) of other bank(s). Furthermore, the remap unit and the virtual mapping data are used to determine whether to retrieve the original program code or to retrieve the remap program code so as to fully utilize the common area(s) of the bank(s).

### BRIEF DESCRIPTION OF THE DRAWINGS

The invention will become more fully understood from the detailed description given here in below illustration only, and thus is not limitative of the present invention, and wherein:

FIG. 1 is a schematic diagram showing a conventional layout of a bank;

FIG. 2 is a schematic diagram showing a part of a conventional electronic system;

FIG. 3 is a schematic diagram showing a method for generating a bank with a remap function according to an embodiment of the invention; and

FIG. 4 is a schematic diagram showing a part of an electronic system with a remap function according to an embodiment of the invention.

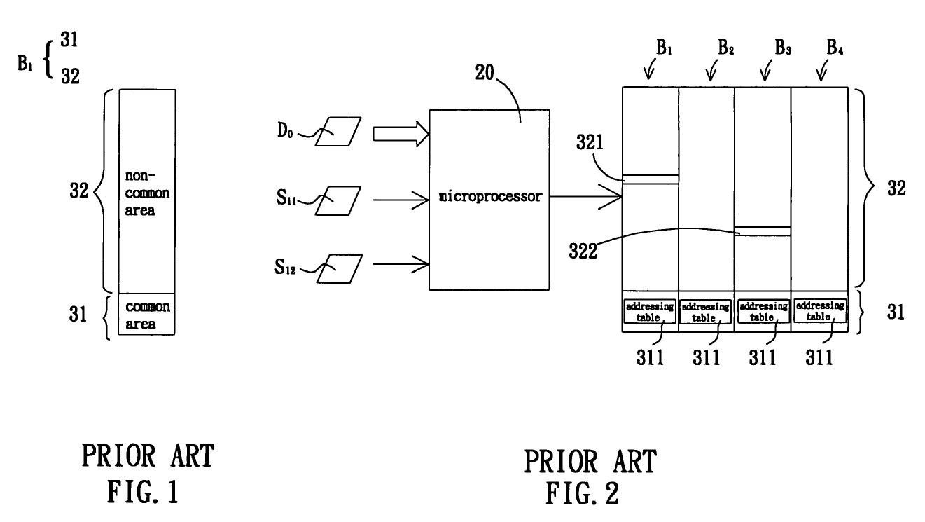

### DETAILED DESCRIPTION OF THE INVENTION

The method for generating a bank with a remap function of the present invention will be apparent from the following detailed description, which proceeds with reference to the accompanying drawings, wherein the same references relate to the same elements.

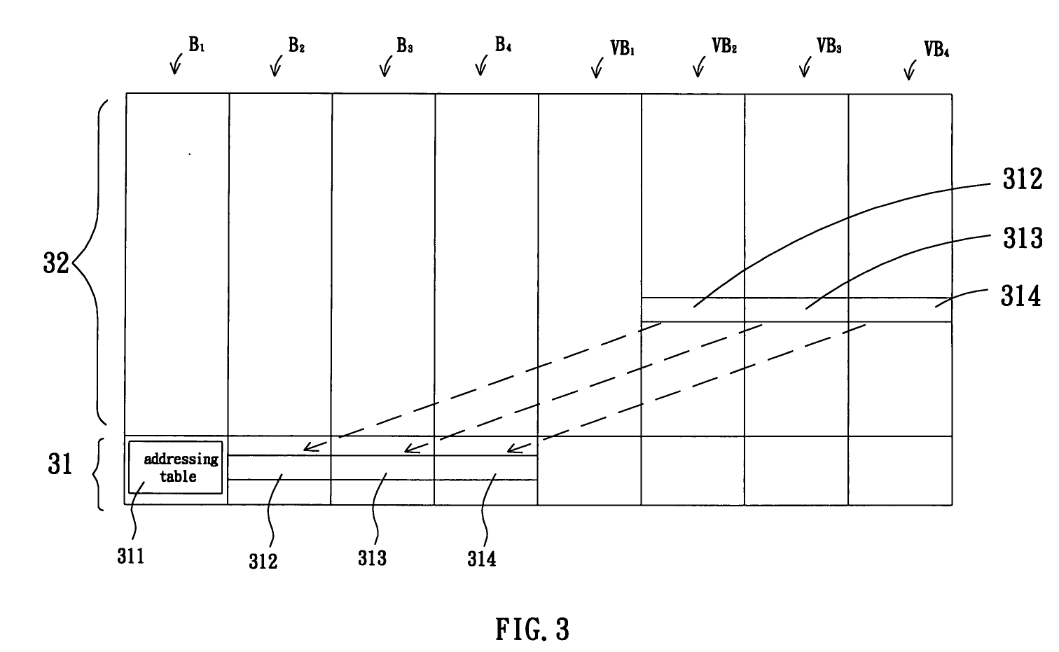

Referring to FIG. 3, a method for generating a bank with a remap function according to an embodiment of the invention, taking a firmware of an electronic system as an example, is cooperated with a first bank B₁, a second bank B₂, a third bank B₃, and a fourth bank B₄. The size of each bank is 64 KB, and each bank has a common area 31 and a non-common area 32. In general, the ratio of the size of the common area 31 to the size of the non-common area 32 is substantially about 1:5. However, it should not be limited for this invention. The common area 31 of the first bank B₁ has an addressing table 311, and the non-common areas of the first, second, third, and fourth banks comprise at least one original program code, respectively. In the embodiment, the address of each of the original program codes and the addressing table is expressed by a binary code having 16 bits. The method comprises the following steps.

Firstly, a firmware development tool (such as the C51 of Keil C) is employed to generate a first virtual bank VB₁, a second virtual bank VB₂, a third virtual bank VB₃, and a fourth virtual bank VB₄.

After that, a second remap program code 312, a third remap program code 313, and a fourth remap program code 314 to be added are addressed into the second virtual bank VB₂, the third virtual bank VB₃, and the fourth virtual bank VB₄. In the embodiment, the address of the second remap program code 312, the third remap program code 313, and the fourth remap program code 314 are started from the 32nd KB of the second virtual bank VB₂, the third virtual bank VB₃, and the fourth virtual bank VB₄ respectively.

Then, the firmware development tool is used to compile/link the firmware. In the present embodiment, there are eight banks and the size of the compiled/linked firmware may grow up to 512 KB. However, the real firmware size of the electronic system is 256 KB, so that the remap program codes stored in the virtual banks must be transferred into the corresponding real banks. In the embodiment, the second remap program code 312 stored in the second virtual bank VB₂ is transferred into the common area 31 of the second bank B₂, the third remap program code 313 stored in the third virtual bank VB₃ is transferred into the common area 31 of the third bank B₃, and the fourth remap program code 314 stored in the fourth virtual bank VB₄ is transferred into the common area 31 of the fourth bank B₄. In this case, the above step can be carried out by changing the value of one of the bits of the address directing to the remap program code stored in the virtual bank, so as to generate the address in the corresponding common area 31 of the bank where the remap program code to be transferred. Then, the remap program code is transferred into the corresponding common area of bank in accordance with the generated address. In the embodiment, only the value of the first bit of the remap program code address in the virtual bank is changed to generate the address corresponding to the common area of bank.

This step will overwrite the content of each of the common areas 31 of the second bank B₂, third bank B₃, and fourth bank B₄. Comparing with the conventional bank structure, the addressing tables stored in all common areas have the same contents, and, in the embodiment, only the addressing table 311 stored in the common area 31 of the first bank B₁ is preserved while the other addressing tables are unnecessary. It should be noted that the size of the remap program code must less than or equal to the capacity of the common area of the bank to avoid the non-common area being overwritten by the remap program code, which results in the system error. In addition, the previous-mentioned original program code and remap program code are the firmware of the electronic system.

Finally, the first virtual bank VB₁, the second virtual bank VB₂, the third virtual bank VB₃, and the fourth virtual bank VB₄ are removed, and the first bank B₁, second bank B₂, third bank B₃, and fourth bank B₄ are then saved as 256 KB. After that, the saved contents are record into a memory unit. In the embodiment, the memory can be a Flash ROM.

Hereinafter, an example of an electronic system with a remap function is described to illustrate the effect of the bank with a remap function according to an embodiment of the invention. To be noted, the electronic system can be an optical disk playing/recording system such as a DVD system.

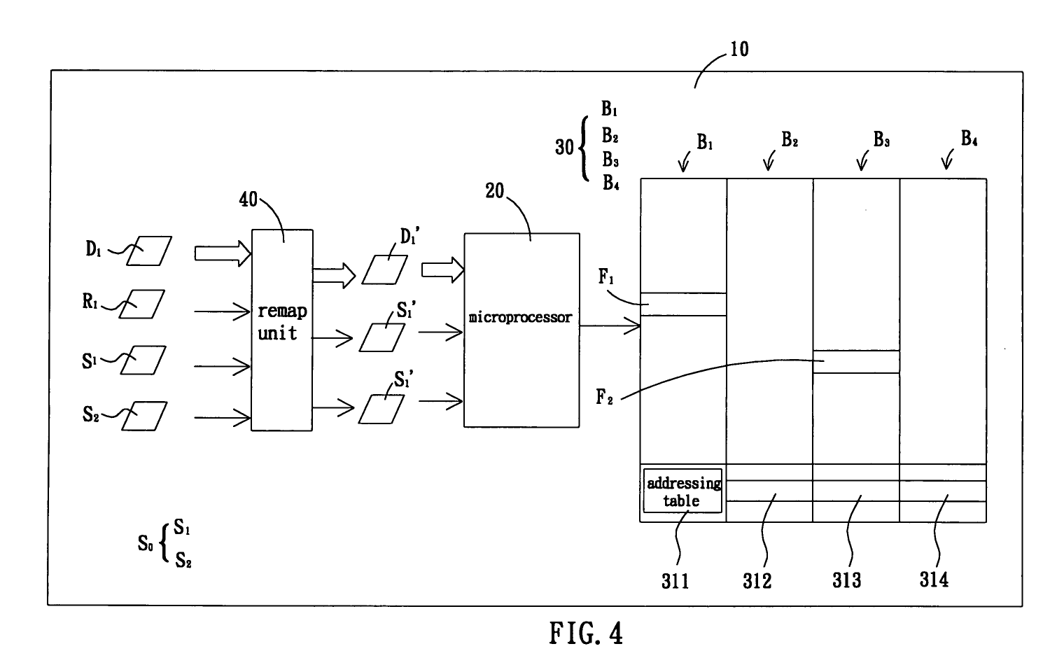

Referring to the FIG. 4, the electronic system 10 with a remap function according to an embodiment of the invention comprises a memory unit 30, a remap unit 40, and a microprocessor 20.

The memory unit 30 has a first bank B₁, a second bank B₂, a third bank B₃, and a fourth bank B₄, and each bank has a common area 31 and a non-common area 32. The common area 31 of the first bank B₁ comprises an addressing table 311, the common area 31 of the second bank B₂ comprises a second remap program code 312, the common area 31 of the third bank B₃ comprises a third remap program code 313, and the fourth bank B₄ comprises a fourth remap program code 314. In addition, the non-common area 32 of each bank comprises at least one original program code. In the current embodiment, the original program codes and the remap program codes are the firmware of the electronic system 10.

The remap unit 40 receives an original address data D₁, an original bank selecting data S₀, and a virtual mapping data R₁. Then, the remap unit 40 generates an embodied bank selecting data S₀′ in accordance with the virtual mapping data R₁ and the original bank selecting data S₀, and generates an embodied address data D₁′ in accordance with the virtual mapping data R₁ and the original address data D₁. In the embodiment, the original address data D₁ and the embodied address data D₁′ are represented by the address value of 16 bits directing to the corresponding banks, respectively, the original bank selecting data S0 is represented by 2 bits, and the mapping data R1 is represented by 1 bit. The original bank selecting data S₀ comprises a first original bank selecting data S₁ and a second original bank selecting data S₂.

In accordance with the embodied bank selecting data S₀′ and embodied address data D₁′, the microprocessor 20 can fetch the original program code from the corresponding address directing to the bank or fetch the remap program code from the second bank, the third bank, or the fourth bank. In the embodiment, if the embodied bank selecting data S₀′ and embodied address data D₁′ direct to the addressing table 311, the microprocessor 20 calls one of the original program code assisted with the addressing table 311; if the embodied bank selecting data S₀′ and embodied address data D₁′ direct to one of the remap program code, the microprocessor 20 calls the remap program code from the corresponding address of the banks, which direct to the common areas of the banks.

The actions of the electronic system with a remap function according to one embodiment of the invention will be described herein below.

When the remap unit 40 receives the original address data D₁, the virtual mapping data R₁, the first original bank selecting data S₁, and the second bank selecting data S₂, it determines whether the virtual mapping data R₁ represents true or not (in the embodiment, if the value of the virtual mapping data R₁ is 1, the virtual mapping data R₁ represents true). If true, the remap unit 40 changes the value of the first bit of the original address data D₁ so as to transfer the original address data D₁ to an embodied address data D₁′. At the same time, the remap unit 40 transfers the first original bank selecting data S₁ and second original bank selecting data S₂ to the first embodied bank selecting data S₁′ and the second embodied bank selecting data S₂′. Herein, the contents of the first original bank selecting data S₁ and the first embodied bank selecting data S₁′ are the same, and the contents of the second original bank selecting data S₂ and the second embodied bank selecting data S₂′ are the same. Then, the remap unit 40 delivers the embodied address data D₁′, the first embodied bank selecting data S₁′ and the second embodied bank selecting data S₂′ to the microprocessor 20. Accordingly, the microprocessor 20 retrieves the remap program code from the common area of the second bank B₂, the third bank B₃, or the fourth bank B₄. If false (i.e. the value of the virtual mapping data R₁ is 0), the remap unit 40 transfers the original address data D₁ to the embodied address data D₁′, which has the same contents as the original address data D₁, and transfers the first original bank selecting data S₁ and the second original bank selecting data S₂ to the first embodied bank selecting data S₁′ of the first bank B₁ and the second embodied bank selecting data S₂′ directing to the first bank B₁. Then, the remap unit 40 delivers the embodied address data D₁′, the first embodied bank selecting data S₁′ and the second embodied bank selecting data S₂′ to the microprocessor 20. Accordingly, the microprocessor 20 retrieves the first original program code F₁ from the designated address. When the contents of the first original program code F₁ need to call the second original program code F₂ stored in the third bank B₃, this calling action has to refer to the addressing table 311 stored in the common area 311 of the first bank B₁. In details, the addressing table 311 stored in the common area 31 of the first bank B₁ may direct the calling action to the third bank B₃ so as to fetch the second original program code F₂ stored in the third bank B₃. At this time, the calling action is done.

As mention above, the electronic system with a remap function of the invention keeps only one addressing table for all of the common areas, which comprise the same contents in the conventional banks, during the firmware development stage. After that, the additional remap program code can be added into the common area(s) of other bank(s). Furthermore, the remap unit and the virtual mapping data are used to determine whether to retrieve the original program code or to retrieve the remap program code so as to fully utilize the common area(s) of the bank(s).

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A method for generating bank with remap function, which cooperates with a first bank and a second bank, wherein each of the first bank and the second bank has a common area and a non-common area, the common area of the first bank stores an addressing table, and each of the non-common areas of the first bank and the second bank comprises at least one original program code, the method comprising:
addressing at least one remap program code into at least one virtual bank; and
transferring the remap program code from the virtual bank to the common area of the second bank.

2. The method according to claim 1, further comprising:
removing the virtual bank after transferring the remap program code to the second bank.

3. The method according to claim 1, further comprising:
recording the first bank and the second bank that comprise the original program code, the addressing table, and the remap program code into a memory unit.

4. The method according to claim 1, further comprising:
recording the first bank and the second bank that comprise the original program code, the addressing table, and the remap program code into a Flash ROM.

5. The method according to claim 1, further comprising:
executing a compile/link after addressing the remap program code into the virtual bank.

6. The method according to claim 1, which changes a bit of an address of the remap program code addressed in the virtual bank to generate an address corresponding to the common area of the second bank, and then transfers the remap program code into the common area of the second bank in accordance with the address corresponding to the common area of the second bank.

7. The method according to claim 1, wherein the size of the remap program code is no greater than a capacity of the common area of the second bank.

8. The method according to claim 1, wherein the original program code and the remap program code are firmware.

9. An electronic system with remap function, comprising:
a memory unit, which at least has a first bank and a second bank, wherein each of the first bank and the second bank has a common area and a non-common area, the common area of the first bank comprises an addressing table, the common area of the second bank comprises at least one remap program code, the non-common areas of the first bank and the non-common area of the second bank respectively comprises at least one original program code;
a remap unit, which receives an original address data, an original bank selecting data, and a virtual mapping data, generates an embodied bank selecting data in accordance with the virtual mapping data and the original bank selecting data, and generates an embodied address data in accordance with the virtual mapping data and the original address data; and
a microprocessor, which fetches the original program code from the first bank or the second bank accordance with the embodied bank selecting data and the embodied address data, or fetches the remap program code from the second bank in accordance with the embodied bank selecting data and the embodied address data.

10. The electronic system according to claim 9, wherein the microprocessor calls one of the original program code via the addressing table when the embodied bank selecting data and the embodied address data direct to the addressing table.

11. The electronic system according to claim 9, wherein the microprocessor calls the remap program code from an address corresponding to the common area of the second bank when the embodied bank selecting data and the embodied address data direct to the remap program code.

12. The electronic system according to claim 9, wherein the memory unit is a Flash ROM.

13. The electronic system according to claim 9, wherein the memory unit further comprising a third bank and a fourth bank.

14. The electronic system according to claim 13, wherein the original bank selecting data is a data with two bits.

15. The electronic system according to claim 9, wherein the electronic system is an optical disk playing system.

16. The electronic system according to claim 9, wherein the electronic system is an optical disk recording system.

17. The electronic system according to claim 9, wherein the electronic system is a DVD system.

18. The electronic system according to claim 9, wherein the electronic system is an optical disk playing system.

19. The electronic system according to claim 9, wherein the original program code and the remap program code are firmware of the electronic system.
